(19) United States
(12) Patent Application Publication
(10) Pub. No.: US 2026/0319999 A1
(43) Pub. Date: Oct. 15, 2026

(54) INFORMATION PROCESSING DEVICE AND INFORMATION PROCESSING METHOD

(71) Applicant: CANON KABUSHIKI KAISHA, Tokyo (JP)

(72) Inventor: Kei HORIUCHI, Saitama (JP)

(21) Appl. No.: 19/576,166

(22) Filed: Mar. 24, 2026

(30) Foreign Application Priority Data
Apr. 14, 2025 (JP) 2025-066364

(51) Int. Cl. G06F 16/13

(52) U.S. Cl. CPC G06F 16/137

(57) ABSTRACT

An information processing device includes: a processor; and a memory storing a program which, when executed by the processor, causes the information processing device to: execute acquisition processing of acquiring a hash value of content data; and record the hash value acquired in the acquisition processing in a predetermined region of a content file that stores the content data, wherein, when combined content data obtained by combining second content data with first content data is generated, a third hash value of the combined content data is acquired in the acquisition processing by using, as an initial value, a first hash value of the first content data recorded in a first content file that stores the first content data or a second hash value of the second content data recorded in a second content file that stores the second content data.

### BACKGROUND

### Field of the Technology

The present disclosure relates to an information processing device and an information processing method.

### Description of the Related Art

In recent years, information sharing via the Internet has been actively performed, and a user can publish and transmit various types of information to an unspecified number of people. In addition, the user can perform various types of processing on a digital image. The information published on the Internet may be transmitted from an unreliable source or may be falsified illegally. As a method for verifying falsification of an image, there is known a method in which a digital camera assigns a hash value generated from an image at the time of imaging to the image and a verification device generates a hash value from the image and compares the hash value with the hash value assigned to the image.

Japanese Patent Laid-Open No. 2011-142425 discloses a technique for shortening a calculation time of a hash value for detecting that content of a part of video and audio is deleted from a video and audio set including a plurality of files or an order or the like of the content is rearranged. “C2PA Specifications” (Coalition for Content Provenance and Authenticity (C2PA), <Technical Specifications Version 1.2>, [online], November 3, 2022, [searched on January 23, 2023], Internet <URL:https://c2pa.org/specifications/specifications/1.2/specs/C2PA_Specification.html>) proposes that metadata including information such as a hash value for certifying authenticity of an image and editing content of the image is assigned to the image in order to certify a source and provenance of the image.

In a case where another content data is combined with content data such as a moving image, a hash value assigned to a file of the combined content data as the information for certifying the authenticity is recalculated. Since the amount of calculation of the hash value increases whenever the content data is added, a generation time of the content file to which the information for certifying the authenticity is assigned also increases.

### SUMMARY

The present disclosure provides an information processing device that reduces the amount of calculation of a hash value assigned as information for certifying authenticity in a case where another content data is combined with content data.

An information processing device according to the present disclosure includes: a processor; and a memory storing a program which, when executed by the processor, causes the information processing device to: execute acquisition processing of acquiring a hash value of content data; and record the hash value acquired in the acquisition processing in a predetermined region of a content file that stores the content data, wherein, when combined content data obtained by combining second content data with first content data is generated, a third hash value of the combined content data is acquired in the acquisition processing by using, as an initial value, a first hash value of the first content data recorded in a first content file that stores the first content data or a second hash value of the second content data recorded in a second content file that stores the second content data.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an imaging device.

FIG. 2 is a diagram illustrating a configuration of a content file.

FIG. 3 is a diagram illustrating a configuration of authenticity certificate information.

FIG. 4A is a diagram illustrating a configuration of a combination source content file. FIG. 4B is a diagram illustrating a configuration of an additional content file. FIG. 4C is a diagram illustrating a configuration of a combined content file.

FIG. 5 is a flowchart illustrating combined content generation processing of a first embodiment.

FIG. 6 is a flowchart illustrating selection processing of content to be combined.

FIG. 7 is a flowchart illustrating acquisition processing of a hash value.

FIG. 8 is a diagram illustrating a predetermined range of the content file.

FIG. 9A is a diagram illustrating a configuration of the combination source content file. FIG. 9B is a diagram illustrating a configuration of the additional content file. FIG. 9C is a diagram illustrating a configuration of the combined content file.

FIG. 10 is a flowchart illustrating combined content generation processing of a second embodiment.

FIG. 11 is a flowchart illustrating hash value acquisition processing of a combination source.

FIG. 12 is a flowchart illustrating additional recording processing for combination source content.

### DESCRIPTION OF THE EMBODIMENTS

Hereinafter, embodiments of the present disclosure will be described with reference to the drawings. However, the following embodiments are merely examples, and the scope of the present disclosure is not limited to the description of each embodiment.

### First Embodiment

### Device Configuration

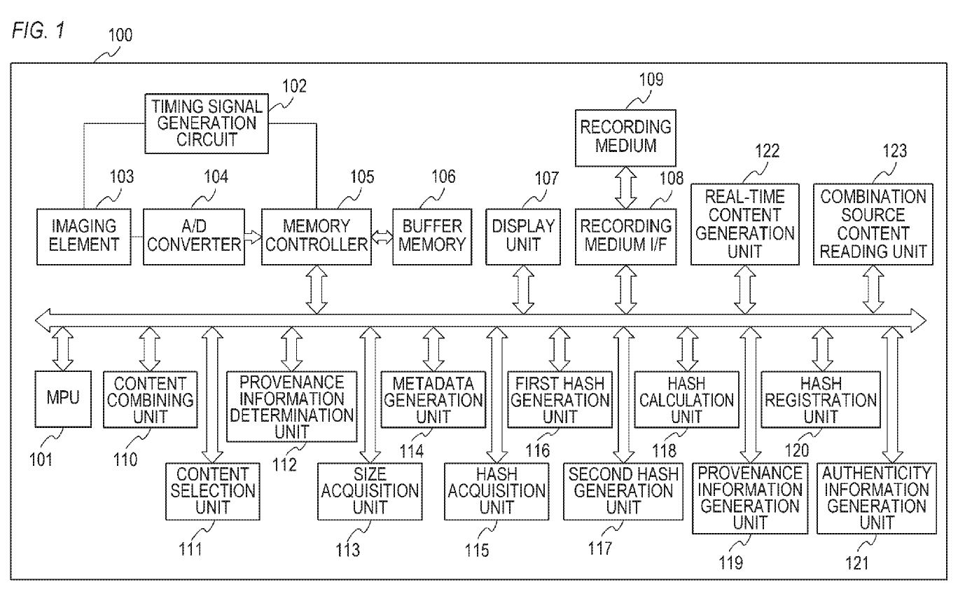

A configuration of an imaging device 100 will be described with reference to FIG. 1. The imaging device 100 is an example of an information processing device according to the present disclosure. Note that the information processing device according to the present disclosure may have a configuration for implementing the present embodiment among configurations of the imaging device 100, and may be a device included in the imaging device 100.

The imaging device 100 includes an MPU 101, a timing signal generation circuit 102, an imaging element 103, an A/D converter 104, a memory controller 105, a buffer memory 106, and a display unit 107. In addition, the imaging device 100 includes a recording medium I/F 108 and a recording medium 109. In addition, the imaging device 100 includes a content combining unit 110, a content selection unit 111, a provenance information determination unit 112, a size acquisition unit 113, a metadata generation unit 114, a hash acquisition unit 115, a first hash generation unit 116, and a second hash generation unit 117. The imaging device 100 includes a hash calculation unit 118, a provenance information generation unit 119, a hash registration unit 120, an authenticity information generation unit 121, a real-time content generation unit 122, and a combination source content reading unit 123.

The MPU 101 is a microcontroller that performs control of the imaging device 100 such as an imaging sequence. The timing signal generation circuit 102 generates a timing signal used to operate the imaging element 103. The imaging element 103 is an imaging element such as a CCD or a CMOS that converts reflected light from an object into an electrical signal (analog image data) and reads the electrical signal to the A/D converter 104. The A/D converter 104 converts analog image data read from the imaging element 103 into digital image data. Hereinafter, the digital image data is simply referred to as “image data”.

The memory controller 105 controls reading and writing of the image data from and to the buffer memory 106, a refresh operation of the buffer memory 106, and the like. The real-time content generation unit 122 generates content in real time on the basis of the image data on the buffer memory 106. In a case where content is added to content of the combination source in real time, the real-time content generation unit 122 can generate additional content corresponding to the combination source content. For example, the real-time content generation unit 122 generates the additional content so as to match a resolution and a frame rate of the combination source content.

The buffer memory 106 is a primary memory that temporarily stores the image data and the content. The buffer memory 106 is, for example, a static random-access memory (SRAM), a dynamic random-access memory (DRAM), or the like.

The display unit 107 displays the content stored in the buffer memory 106. The display unit 107 is a display such as a liquid crystal display (LCD).

The recording medium I/F 108 is an interface for controlling reading and writing of data from and to the recording medium 109. The recording medium 109 is, for example, a storage medium such as a memory card that can be inserted into and removed from the imaging device 100. The recording medium 109 stores programs, content, and the like.

The content combining unit 110 generates combined content obtained by combining the additional content with the combination source content. The content selection unit 111 selects the combination source content and the additional content on the basis of at least one of the presence or absence of the provenance information determined by the provenance information determination unit 112 and a size of content data acquired by the size acquisition unit 113. For example, the content selection unit 111 selects, as the combination source content, one of first content data and second content data stored in the buffer memory 106 and selects the other as the additional content.

The provenance information determination unit 112 determines whether or not the content stored in the buffer memory 106 includes provenance information. The size acquisition unit 113 acquires the size of the content data stored in the buffer memory 106.

The metadata generation unit 114 generates metadata corresponding to media data (content data) of the combined content generated by the content combining unit 110.

The hash acquisition unit 115 acquires a hash value of a predetermined range retained in the provenance information of the combination source content selected by the content selection unit 111. The hash value of the predetermined range is a hash value generated from a predetermined range of the combination source content file. The predetermined range is, for example, a range including the media data.

The first hash generation unit 116 generates and acquires a hash value from the predetermined range (media data) of the combination source content selected by the content selection unit 111. In addition, in a case where the additional content includes the provenance information, the first hash generation unit 116 can generate and acquire the hash value from the predetermined range (media data) of the additional content. The second hash generation unit 117 generates and acquires a hash value for the combined content. The hash calculation unit 118 calculates a hash value from the predetermined range (media data) of the combined content. The media data of the combined content includes media data of the combination source content and media data of the additional content.

The provenance information generation unit 119 generates the provenance information of the combined content on the basis of the hash value of the combined content generated by the second hash generation unit 117. The hash registration unit 120 registers the hash value of the predetermined range of the combined content calculated by the hash calculation unit 118 in the provenance information.

The authenticity information generation unit 121 generates data used for a signature (hereinafter, described as signature data) and a signature on the basis of the provenance information in which the hash registration unit 120 registers the hash value of the predetermined range. The authenticity information generation unit 121 generates information (hereinafter, described as authenticity certificate information) for certifying the authenticity of the combined content on the basis of the provenance information, the signature data, and the signature. The combination source content reading unit 123 reads content serving as the combination source stored in the buffer memory 106.

Note that a configuration of the imaging device 100 illustrated in FIG. 1 is merely an example. When the function and processing of the imaging device 100 can be realized, the configuration of the imaging device 100 is not limited to the configuration illustrated in FIG. 1. In accordance with the function realized by the imaging device 100, the imaging device 100 may include a configuration other than the configuration illustrated in FIG. 1.

### Configuration of Content File

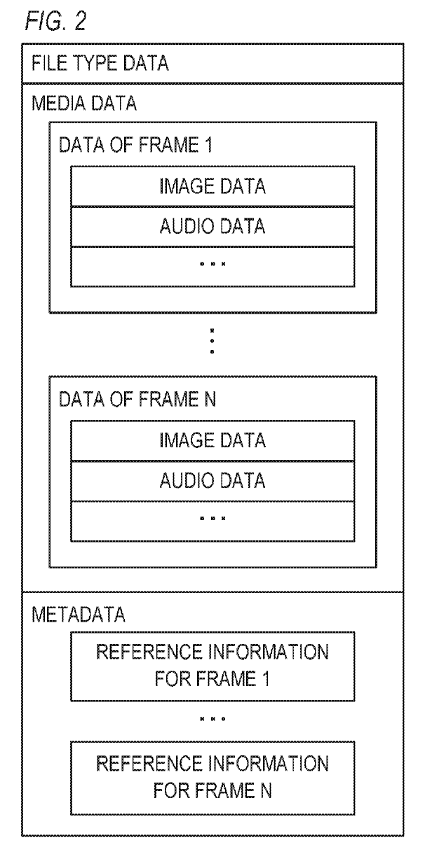

A configuration of a content file will be described with reference to FIG. 2. The content file is, for example, a moving image file in a format conforming to ISO/IEC 14496-15 (NALU File Format: Carriage of NAL unit video in ISOBMFF). FIG. 2 illustrates a data structure of the moving image file conforming to ISO/IEC 14496-15. Note that the content file is not limited to the moving image file, and may be an image file or an audio file.

The content file includes file type data, media data, and metadata. The file type data is data indicating a type and compatibility of the file. The media data stores a plurality of pieces of data in units of frames. The pieces of data in units of frames include image data and audio data. The metadata is information for managing the media data. The metadata includes reference information for data in each unit of frames. The reference information includes information such as a storage location of data in each unit of frames.

### Configuration of Authenticity Certificate Information

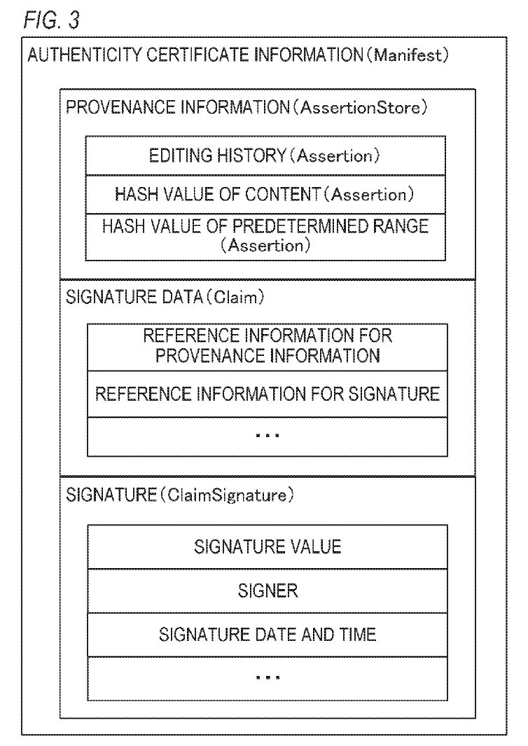

A configuration of the authenticity certificate information will be described with reference to FIG. 3. The authenticity certificate information is, for example, Manifest in a standard defined by Coalition for Content Provenance and Authenticity (C2PA). Manifest stores information called AssertionStore, Claim, and ClaimSignature.

AssertionStore is provenance information that stores Assertion used to certify the authenticity of the content, such as an editing history of the content, a hash value of the content, and a hash value of a predetermined range of the content. Claim stores signature data used for performing digital signature, such as reference information for each Assertion of the provenance information and reference information for the signature. The reference information includes, for example, information indicating a storage location of corresponding data. ClaimSignature stores data related to a result of the digital signature, such as a signature value, a signer, and a signature date and time.

A region for storing the hash value of the content is, for example, Assertion for storing the hash value of the entire content (file type data, media data, and metadata). A region for storing the hash value of the predetermined range is a region newly added as Assertion for storing the hash value of the media data (content data) of the content. A region for storing the hash value of the predetermined range corresponds to a predetermined region. The data included in Manifest illustrated in FIG. 3 is an example in the standard defined by the C2PA. Manifest may include another piece of management information defined in the C2PA standard in addition to the management information illustrated in FIG. 3.

### Configuration of Combined Content File

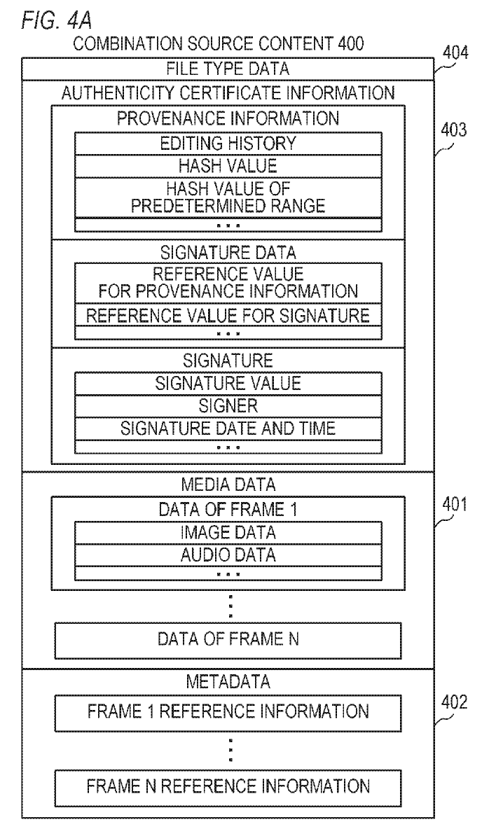

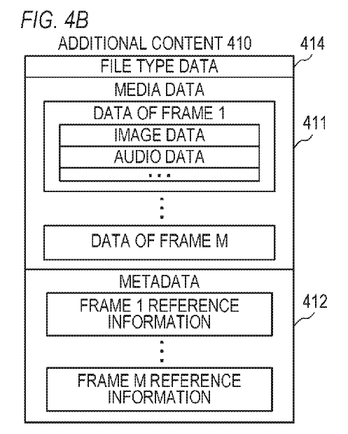

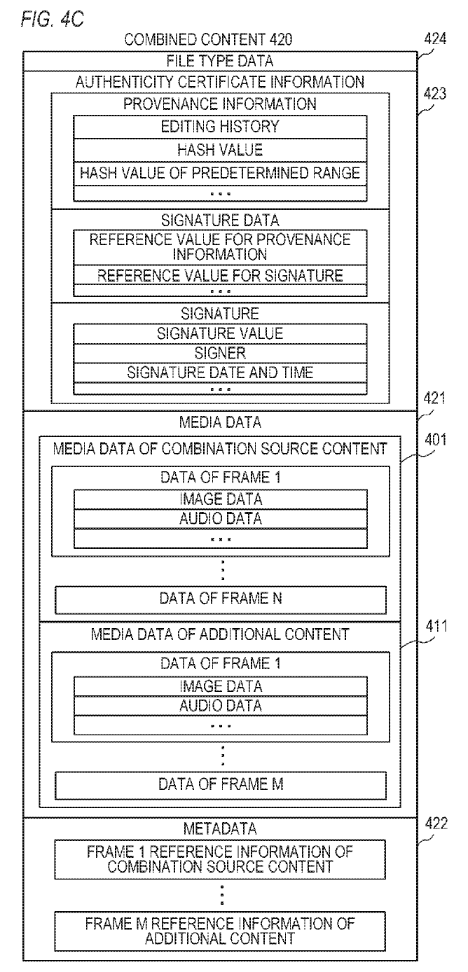

A configuration of a combined content file according to a first embodiment will be described with reference to FIGS. 4A to 4C. FIG. 4A is a diagram illustrating a configuration of a combination source content file. FIG. 4B is a diagram illustrating a configuration of an additional content file. FIG. 4C is a diagram illustrating a configuration of a combined content file. Hereinafter, the content file is also simply described as content.

The combination source content 400 (first content file) includes file type data 404, media data 401, and metadata 402, similarly to the content file described in FIG. 2. In addition, the combination source content 400 includes authenticity certificate information 403.

Additional content 410 (second content file) has a configuration similar to that of the content file described in FIG. 2, and includes file type data 414, media data 411, and metadata 412. In addition, the additional content 410 does not include authenticity certificate information.

Combined content 420 is content obtained by combining the additional content 410 with the combination source content 400. Similarly to the content file described in FIG. 2, the combined content 420 includes file type data 424, media data 421, and metadata 422. In addition, the combined content 420 includes authenticity certificate information 423.

The media data 421 of the combined content 420 is data in which the media data 401 of the combination source content 400 and the media data 411 of the additional content 410 are combined. The media data 421 of the combined content 420 is generated by the content combining unit 110.

The metadata 422 of the combined content 420 is generated by the metadata generation unit 114 on the basis of the media data 421 of the combined content 420. The metadata 422 includes reference information for each of frame 1 to frame N of the media data 401 of the combination source content included in the media data 421. In addition, the metadata 422 includes reference information for each of the frame 1 to frame M of the media data 411 of the additional content included in the media data 421.

The authenticity certificate information 423 of the combined content 420 is generated by the authenticity information generation unit 121 by using the provenance information generated by the provenance information generation unit 119. The authenticity certificate information 423 is arranged between the file type data 424 and the media data 421. As described above, in a case where the content file includes the authenticity certificate information, the authenticity certificate information is arranged between the file type data and the media data.

FIGS. 4A and 4B illustrate an example in which the combination source content 400 includes the authenticity certificate information 403 and the additional content 410 does not include the authenticity certificate information, but the present disclosure is not limited thereto. Both the combination source content 400 and the additional content 410 may include the authenticity certificate information, or neither the combination source content 400 nor the additional content 410 may include the authenticity certificate information. Note that, in a case where the combination source content 400 and the additional content 410 do not include the authenticity certificate information, the hash value of the media data (content data) may be retained in another region (predetermined region) in which metadata or the like is recorded.

### Combined Content Generation Processing

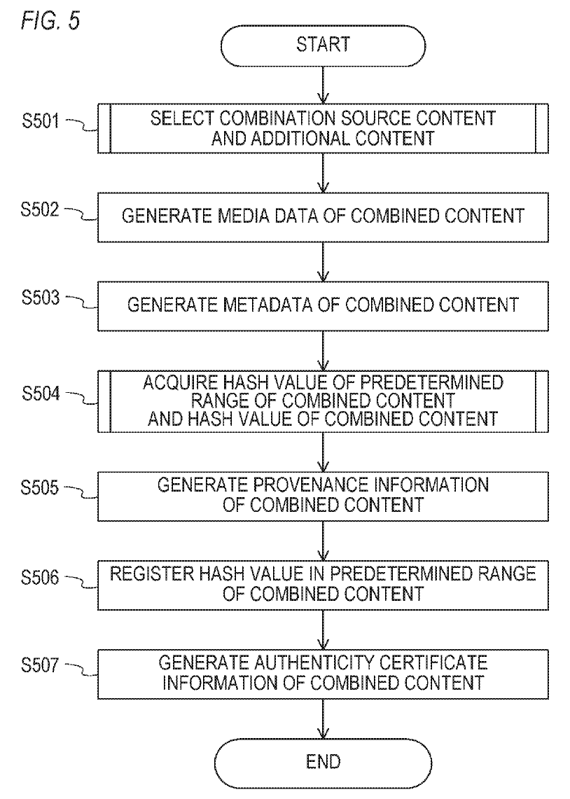

Combined content generation processing according to the first embodiment will be described with reference to FIG. 5. The combined content generation processing is processing of combining the additional content (second content file) with the combination source content (first content file) to generate the combined content (combined content file). The processing illustrated in FIG. 5 is realized by the MPU 101 controlling each functional unit of the imaging device 100. The combined content generation processing of the first embodiment is started in a state where the combination source content and the additional content to be combined are read from the recording medium 109 and temporarily stored in the buffer memory 106.

In step S501, the content selection unit 111 selects the combination source content and the additional content from the content stored in the buffer memory 106. For example, the content selection unit 111 selects the combination source content and the additional content according to an instruction from a user.

In step S502, the content combining unit 110 generates the media data of the combined content from the combination source content and the additional content selected in step S501. The content combining unit 110 combines the media data (second content data) of the additional content with the media data (first content data) of the combination source content to generate the media data (combined content data) of the combined content.

In step S503, the metadata generation unit 114 generates the metadata of the combined content on the basis of the media data of the combined content generated in step S502.

In step S504, the hash calculation unit 118 calculates and acquires the hash value of the predetermined range of the combined content from the hash value of the predetermined range of the combination source content and the media data of the additional content. In addition, the second hash generation unit 117 generates and acquires the hash value of the combined content from the hash value of the predetermined range of the combined content and the metadata of the combined content generated in step S503.

In step S505, the provenance information generation unit 119 generates the provenance information of the combined content from the hash value of the combined content acquired in step S504.

In step S506, the hash registration unit 120 registers the hash value of the predetermined range of the combined content acquired in step S504 in the provenance information generated in step S505.

In step S507, the authenticity information generation unit 121 generates the signature data (Claim) and the signature (ClaimSignature) from the provenance information (AssertionStore) generated in step S505. The authenticity information generation unit 121 generates authenticity certificate information including the provenance information, the signature data, and the signature. The authenticity information generation unit 121 can generate the combined content that stores the authenticity certificate information by arranging the generated authenticity certificate information between the file type data and the media data of the combined content.

### Selection Processing of Content to be Combined

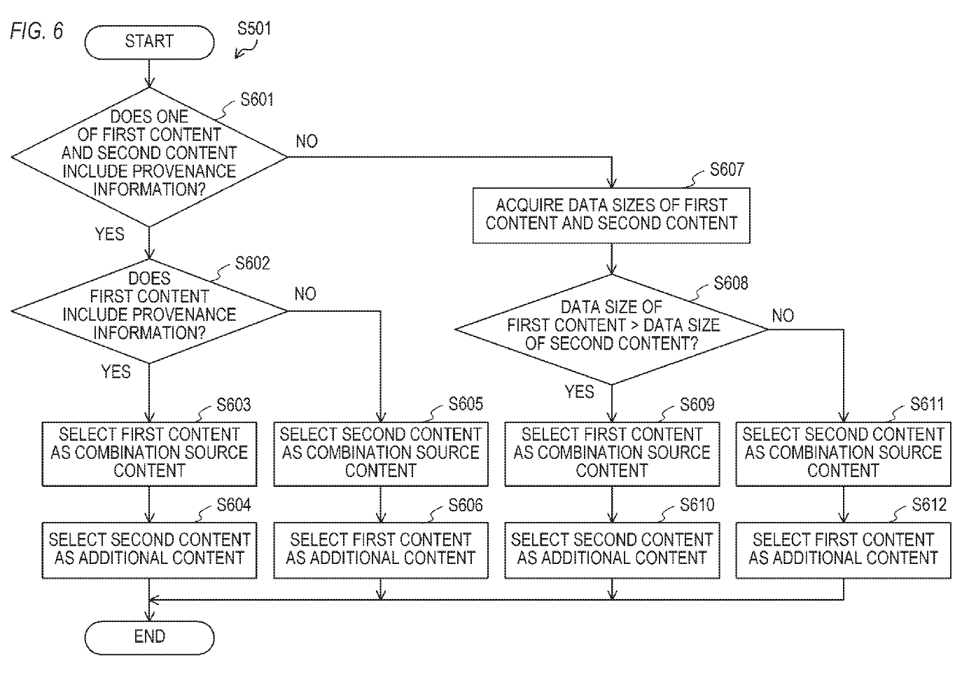

Selection processing of content to be combined will be described with reference to FIG. 6. FIG. 6 illustrates details of the processing described in step S501 of FIG. 5. The selection processing of the content to be combined is processing of selecting the combination source content and the additional content.

In step S601, the provenance information determination unit 112 determines whether or not only one of first content and second content, which are two contents read from the buffer memory 106, includes the provenance information. The provenance information is information recorded in a predetermined region of the content file. The predetermined region is, for example, a region in which AssertionStore of the authenticity certificate information is recorded.

In a case where one of the first content and the second content includes the provenance information, the processing proceeds to step S602. In a case where both the first content and the second content include the provenance information, or in a case where both the first content and the second content do not include the provenance information, the processing proceeds to step S607.

In step S602, the provenance information determination unit 112 determines whether or not the first content includes the provenance information. In a case where the first content includes the provenance information in step S602, the second content does not include the provenance information. In a case where the first content includes the provenance information, the processing proceeds to step S603. In addition, in a case where the first content does not include the provenance information in step S602, the second content includes the provenance information. In a case where the first content does not include the provenance information, the processing proceeds to step S605.

In step S603, the content selection unit 111 selects the first content as the combination source content. In step S604, the content selection unit 111 selects the second content as the additional content. In steps S603 and S604, only the first content includes the provenance information, and the hash value of the combined content is acquired by using the hash value recorded in the provenance information of the first content as an initial value.

In step S605, the content selection unit 111 selects the second content as the combination source content. In step S606, the content selection unit 111 selects the first content as the additional content. In steps S605 and S606, only the second content includes the provenance information, and the hash value of the combined content is acquired by using the hash value recorded in the provenance information of the second content as the initial value.

In step S607, the content selection unit 111 acquires data sizes of the first content and the second content. Note that the data size of the content may be a size of the media data of the content or a data size of the content file.

In step S608, the content selection unit 111 determines whether or not the data size of the first content is larger than the data size of the second content. In a case where the data size of the first content is larger than the data size of the second content, the processing proceeds to step S609. In a case where the data size of the first content is equal to or smaller than the data size of the second content, the processing proceeds to step S611.

In step S609, the content selection unit 111 selects the first content as the combination source content. In step S610, the content selection unit 111 selects the second content as the additional content. In this case, the hash value of the combined content is acquired by using the hash value recorded in the provenance information of the first content as the initial value.

In step S611, the content selection unit 111 selects the second content as the combination source content. In step S612, the content selection unit 111 selects the first content as the additional content. In this case, the hash value of the combined content is acquired by using the hash value recorded in the provenance information of the second content as the initial value.

The content selection unit 111 can select an appropriate combination source content (combination source content file) according to the flowchart illustrated in FIG. 6.

Note that the content selection unit 111 may select the combination source content and the additional content according to the selection of the user. In a case where the user selects the first content (first content file) as the combination source content, the hash value of the combined content is acquired by using the hash value of the first content as the initial value. In a case where the user selects the second content (second content file) as the combination source content, the hash value of the combined content is acquired by using the hash value of the second content as the initial value.

### Acquisition Processing of Hash Value

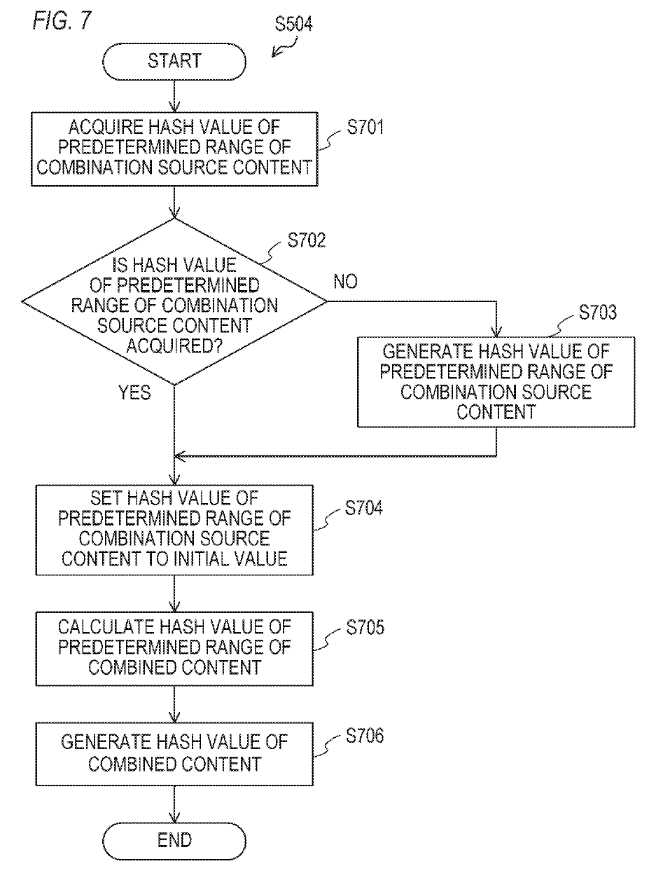

Acquisition processing of the hash value will be described with reference to FIG. 7. FIG. 7 illustrates details of the processing described in step S504 of FIG. 5. The acquisition processing of the hash value is processing of acquiring the hash value of the predetermined range of the combined content and the hash value of the combined content.

In step S701, the hash acquisition unit 115 acquires the hash value of the predetermined range included in the provenance information of the combination source content. The predetermined range is, for example, the media data of the combination source content.

In step S702, the hash acquisition unit 115 determines whether or not the hash value of the predetermined range of the combination source content is acquired in step S701. For example, in a case where the hash value of the predetermined range of the combination source content is not recorded in the provenance information of the combination source content file, the hash acquisition unit 115 fails to acquire the hash value. In a case where the hash value of the predetermined range of the combination source content is acquired, the processing proceeds to step S704. In a case where the hash value of the predetermined range of the combination source content is not acquired, the processing proceeds to step S703.

Since the hash value of the predetermined range is not acquired from the combination source content in step S702, the first hash generation unit 116 generates the hash value of the predetermined range of the combination source content in step S703. The first hash generation unit 116 can acquire, as the hash value of the predetermined range, the hash value generated from the media data (content data) of the combination source content. As described above, in a case where the hash value of the predetermined range of the combination source content is not recorded in the combination source content file, the first hash generation unit 116 generates and acquires the hash value of the predetermined range of the combination source content from the media data of the combination source content.

In step S704, the hash calculation unit 118 sets the hash value of the predetermined range of the combination source content acquired in step S701 or step S703, to an initial value when the hash value of the predetermined range of the combined content is calculated.

In step S705, the hash calculation unit 118 hashes the media data of the additional content in a state where the hash value of the predetermined range of the combination source content is set to the initial value. The hash calculation unit 118 acquires a result of hashing the media data of the additional content, as the hash value of the predetermined range (media data) of the combined content by using the hash value of the predetermined range of the combination source content as the initial value.

In step S706, the second hash generation unit 117 sets the hash value of the predetermined range of the combined content calculated in step S705 to the initial value, and hashes the metadata of the combined content generated in step S503 in FIG. 5. The second hash generation unit 117 generates and acquires a result of hashing the metadata of the combined content as the hash value of the combined content by using the hash value of the predetermined range of the combined content as the initial value.

### Predetermined Range of Content File

The imaging device 100 acquires a hash value generated from data in the predetermined range of the content file as the hash value of the content data. The predetermined range may be the entire media data or an aligned range of the media data. In addition, the predetermined range may be the entire content including the metadata or the like. As described above, the predetermined range can be set to various ranges in accordance with a situation.

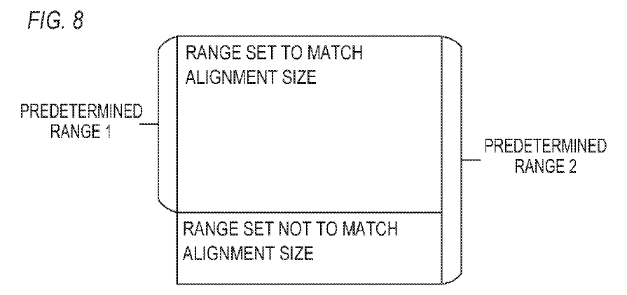

The predetermined range of the content file will be described with reference to FIG. 8. A predetermined range 1 illustrated in FIG. 8 is a range set so as to match the data size (hereinafter, described as an alignment size) of alignment when the hash value is generated. A predetermined range 2 is a range including a range that does not match the alignment size.

Depending on a hash calculation method, hash calculation is performed in units of blocks of the alignment size. In a case where a data size input to a hash function does not match the alignment size, padding (0 filling) is performed in internal processing of the hash calculation in order to align the input data with the alignment size. For example, in a range that does not match the alignment size of the predetermined range 2, the hash value of the predetermined range 2 is generated in a state where 0 that is not included in the content is added by padding.

In a case where the padded hash value of the predetermined range 2 of the combination source content is set to the initial value, the hash value of the predetermined range of the combined content is generated by hashing the additional content. That is, the hash value of the predetermined range of the combined content is generated from data including 0 that is not originally present between the combination source content and the additional content. In this case, when the authenticity of the combined content is verified, the hash value of the predetermined range acquired from the combined content is acquired by adding 0 for padding.

On the other hand, in a case where the hash value of the predetermined range 1 of the combination source content is set to the initial value, the hash value of the predetermined range of the combined content is generated by hashing the range not matching the alignment size and the additional content. That is, the hash value of the predetermined range of the combined content is generated from data that does not include 0 by padding between the combination source content and the additional content. Accordingly, it is possible to acquire the hash value of the predetermined range from the combined content without considering the influence of padding. In addition, a processing load due to padding is reduced.

In the first embodiment described above, when the additional content is combined with the combination source content and the hash value to be recorded in the provenance information is calculated, the imaging device 100 acquires the hash value of the combined content by using the hash value of the combination source content as the initial value. The hash value of the combination source content is set to the initial value, and thus, the imaging device 100 may not hash the entire media data of the combined content obtained by combining the media data of the combination source content and the media data of the additional content from the beginning. Since the imaging device 100 may hash the media data of the additional content, the amount of calculation for acquiring the hash value can be reduced.

Note that, as described with reference to FIG. 6, the imaging device 100 can select one of two contents to be combined as the combination source content and the other as the additional content. In a case where the second content is content to be played back after the first content and the second content is selected as the combination source content, the content file of the combined content may include management information for controlling a playback order. The management information for controlling the playback order includes information for controlling the media data of the first content which is the additional content to be played back before the media data of the second content which is the combination source content.

### Second Embodiment

The first embodiment is an embodiment in a case where two recorded contents are combined. In the first embodiment, the imaging device 100 can reduce the amount of calculation of the hash value when the hash value of the combined content is acquired from the two types of content recorded in the recording medium 109. On the other hand, a second embodiment is an embodiment in a case where captured images captured by the imaging device 100 as the additional content are combined with the combination source content in real time.

Components similar to those in the first embodiment are denoted by the same reference numerals as those in the first embodiment, and a detailed description thereof will be omitted. Description overlapping with that of the first embodiment will be omitted, and description will be given focusing on portions different from those of the first embodiment. A configuration of the imaging device 100 according to the second embodiment is the same as the configuration of the imaging device 100 according to the first embodiment described with reference to FIG. 1.

### Configuration of Combined Content File

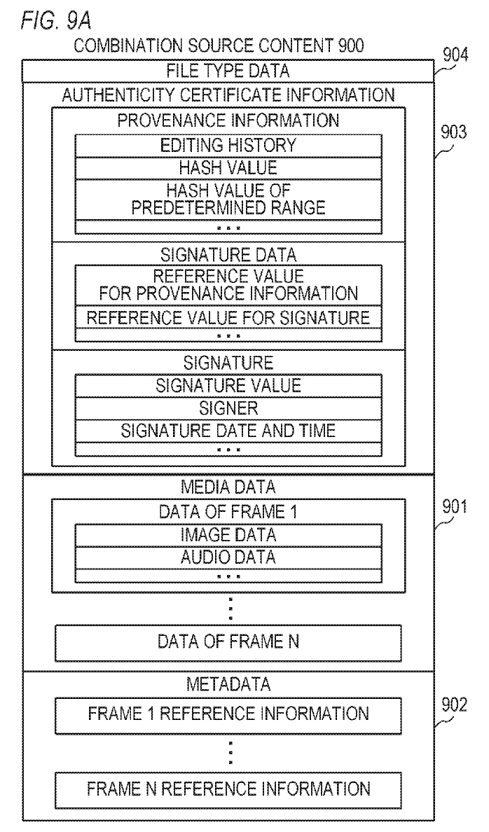

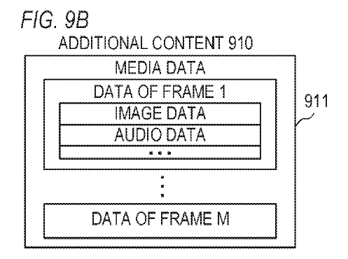

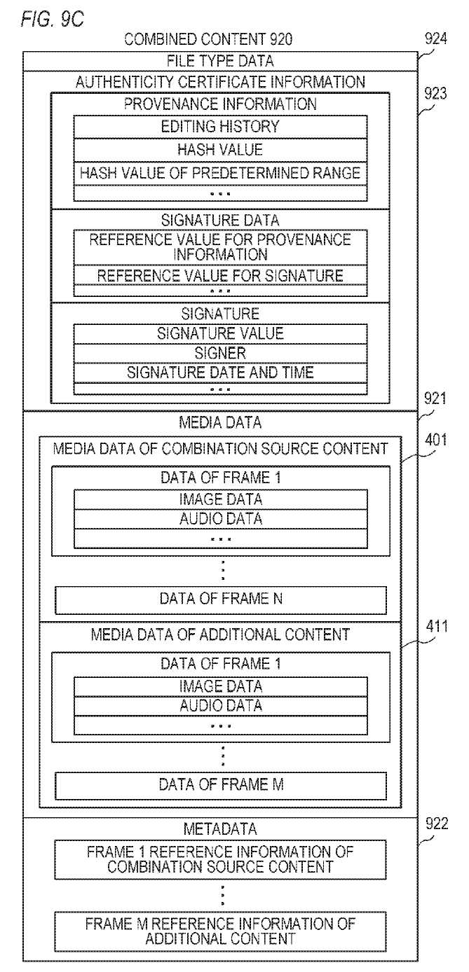

A configuration of the combined content file according to the second embodiment will be described with reference to FIGS. 9A to 9C. FIG. 9A is a diagram illustrating a configuration of a combination source content file. FIG. 9B is a diagram illustrating a configuration of an additional content file. FIG. 9C is a diagram illustrating a configuration of a combined content file. Hereinafter, the content file is also simply described as content.

A combination source content 900 (first content file) includes file type data 904, media data 901, and metadata 902, similarly to the content file described in FIG. 2. In addition, the combination source content 900 includes authenticity certificate information 903.

Additional content 910 (second content file) is content generated in real time. The additional content 910 is content that includes media data 911 and does not include metadata.

Combined content 920 is content acquired by combining captured images acquired in real time with the combination source content 900 as the additional content. Similarly to the content file described in FIG. 2, the combined content 920 includes file type data 924, media data 921, and metadata 922. In addition, the combined content 920 includes authenticity certificate information 923.

The media data 921 of the combined content 920 is data in which the media data 911 of the additional content 910 is added to the media data 901 of the combination source content 900. The media data 921 of the combined content 920 is generated by the content combining unit 110.

The metadata 922 of the combined content 920 is generated by the metadata generation unit 114 on the basis of the media data 921 of the combined content 920. The metadata 922 includes reference information for each of frame 1 to frame N of the media data 901 of the combination source content included in the media data 921. In addition, the metadata 922 includes reference information for each of the frame 1 to frame M of the media data 911 of the additional content included in the media data 921.

The authenticity certificate information 923 of the combined content 920 is generated by the authenticity information generation unit 121 by using the provenance information generated by the provenance information generation unit 119. FIG. 9A illustrates an example in which the combination source content 900 includes the authenticity certificate information, but the combination source content 900 may not include the authenticity certificate information. Note that, in a case where the authenticity certificate information is not included, the combination source content 900 may retain the hash value of the media data (content data) in another region (predetermined region) in which the metadata or the like is recorded.

### Combined Content Generation Processing

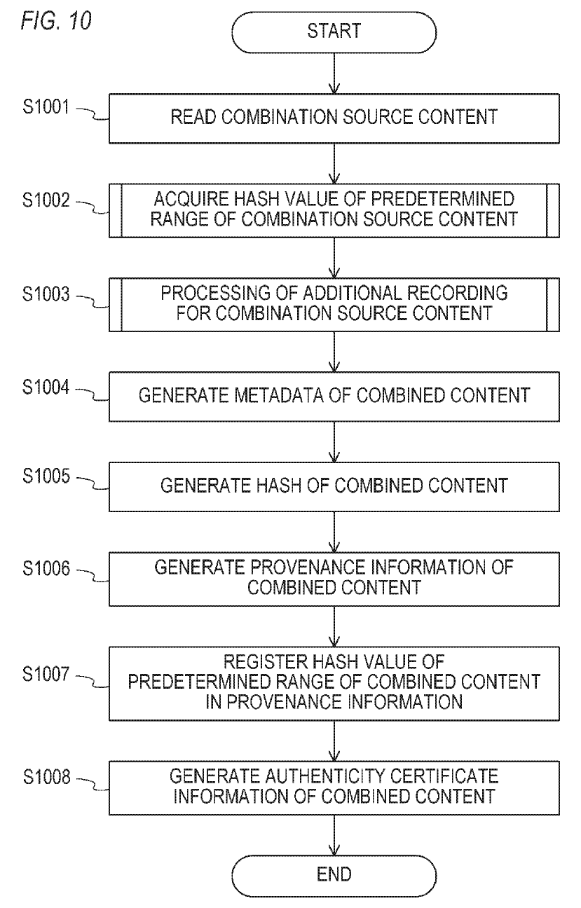

The combined content generation processing according to the second embodiment will be described with reference to FIG. 10. The processing illustrated in FIG. 10 is realized by the MPU 101 controlling each functional unit of the imaging device 100. The combined content generation processing of the second embodiment is started in a state where the combination source content is read from the recording medium 109 and temporarily stored in the buffer memory 106.

In step S1001, the combination source content reading unit 123 reads the content stored in the buffer memory 106, as the combination source content.

In step S1002, the MPU 101 acquires the hash value of the predetermined range of the combination source content read in step S1001. The acquired hash value is set to the initial value when the hash value of the combined content is acquired.

In step S1003, the content combining unit 110 combines the additional content generated by the real-time content generation unit 122 with the combination source content read in step S1001. The content combining unit 110 acquires the media data of the combined content by combining the media data of the additional content with the media data of the combination source content. In addition, the hash calculation unit 118 calculates and acquires the hash value of the predetermined range recorded in the provenance information of the combined content.

In step S1004, the metadata generation unit 114 generates the metadata of the combined content from the media data of the combined content combined in step S1003.

In step S1005, the second hash generation unit 117 generates the hash value of the combined content from the hash value of the predetermined range of the combined content acquired in step S1003 and the metadata of the combined content generated in step S1004.

In step S1006, the provenance information generation unit 119 generates the provenance information of the combined content from the hash value of the combined content generated in step S1005.

In step S1007, the hash registration unit 120 registers the hash value of the predetermined range of the combined content acquired in step S1003 in the provenance information generated in step S1006.

In step S1008, the authenticity information generation unit 121 generates the signature data and the signature from the provenance information of the combined content generated in step S1006. The authenticity information generation unit 121 generates authenticity certificate information including the provenance information, the signature data, and the signature. The authenticity information generation unit 121 can generate the combined content that stores the authenticity certificate information by arranging the generated authenticity certificate information at a position between the file type data and the media data of the combined content.

### Hash Value Acquisition Processing in Predetermined Range of Combination Source Content

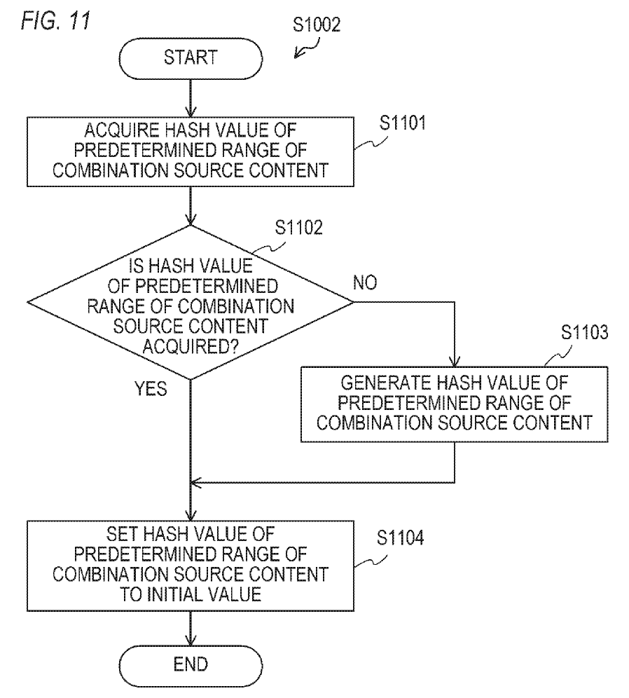

Hash value acquisition processing for the hash value of the predetermined range of the combination source content will be described with reference to FIG. 11. FIG. 11 illustrates details of the processing described in step S1002 of FIG. 10.

In step S1101, the hash acquisition unit 115 acquires the hash value of the predetermined range included in the provenance information of the combination source content. The predetermined range is, for example, the media data of the combination source content.

In step S1102, the hash acquisition unit 115 determines whether or not the hash value of the predetermined range of the combination source content is acquired in step S1101. For example, in a case where the hash value of the predetermined range of the combination source content is not recorded in the provenance information of the combination source content file, the hash acquisition unit 115 fails to acquire the hash value. In a case where the hash value of the predetermined range of the combination source content is acquired, the processing proceeds to step S1104. In a case where the hash value of the predetermined range of the combination source content is not acquired, the processing proceeds to step S1103.

Since the hash value of the predetermined range is not acquired from the combination source content in step S1102, the first hash generation unit 116 generates the hash value of the predetermined range of the combination source content in step S1103. The first hash generation unit 116 can acquire, as the hash value of the predetermined range, the hash value generated from the media data (content data) of the combination source content. As described above, in a case where the hash value of the predetermined range of the combination source content is not recorded in the combination source content file, the first hash generation unit 116 generates and acquires the hash value of the predetermined range of the combination source content from the media data of the combination source content.

In step S1104, the hash calculation unit 118 sets the hash value of the predetermined range of the combination source content acquired in step S1101 or step S1103 to the initial value when the hash value of the predetermined range of the combined content is calculated.

### Additional Recording Processing for Combination Source Content

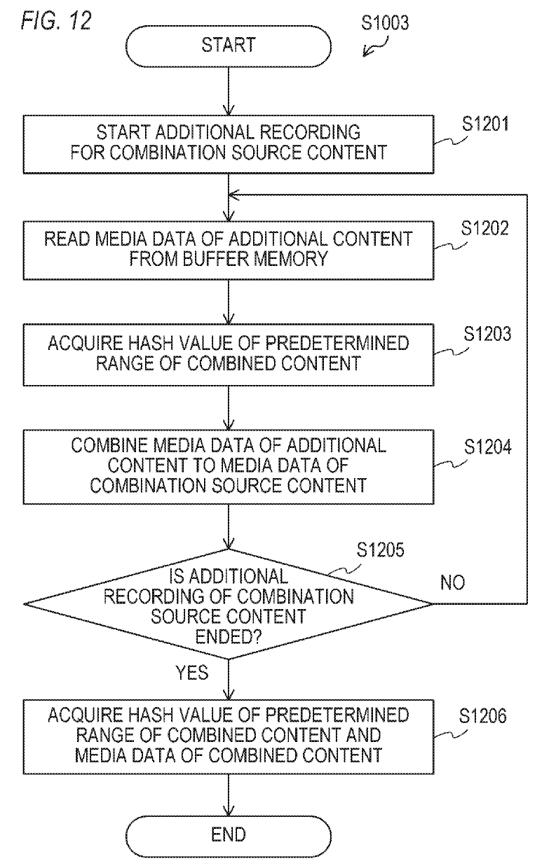

Additional recording processing for the combination source content will be described with reference to FIG. 12. FIG. 12 illustrates details of the processing described in step S1003 of FIG. 10. The additional recording processing for the combination source content is processing of additionally recording the captured images acquired in real time to the combination source content. The processing illustrated in FIG. 12 is started by the imaging device 100 starting imaging. When the processing illustrated in FIG. 12 is started, as described in step S1002 of FIG. 10, the hash value of the predetermined range of the combination source content is set to the initial value.

In step S1201, the MPU 101 starts additional recording for the combination source content. In step S1202, the real-time content generation unit 122 reads the media data of the additional content from the buffer memory 106. The media data of the additional content read from the buffer memory 106 is an image captured by the imaging device 100. Note that the additional content may be an image received in real time from an external imaging device.

In step S1203, the hash calculation unit 118 acquires the hash value of the predetermined range of the combined content from the media data of the additional content read in step S1202. The acquired hash value of the predetermined range of the combined content may be temporarily retained in, for example, the buffer memory 106 or the like. Next, in a case where the media data of the new additional content is combined, the hash calculation unit 118 may hash a new additional content by using the temporarily retained hash value as the initial value.

In step S1204, the content combining unit 110 combines the media data of the additional content read in step S1202 with the media data of the combination source content.

In step S1205, the MPU 101 determines whether or not to end the additional recording for the combination source content. The MPU 101 can determine to end additional recording for the combination source content, for example, in a case where the user performs an operation of stopping imaging processing or an operation of turning off the power of the imaging device 100. In a case where the MPU 101 determines to end additional recording for the combination source content, the processing proceeds to step S1206. In a case where the MPU 101 determines not to end additional recording for the combination source content, the processing returns to step S1202, and the processing of steps S1202 to S1205 is executed.

In step S1206, the hash value of the predetermined range of the combined content and the media data of the combined content are acquired as a final output. The hash value of the predetermined range of the combined content is the hash value acquired and retained by the hash calculation unit 118 in step S1203. The media data of the combined content is the combined media data in which the media data of the additional content is combined with the media data of the combination source content by the content combining unit 110 in step S1204. The hash value of the predetermined range of the combined content acquired in step S1203 is the same as the hash value acquired from the media data of the combined content.

In the second embodiment described above, the imaging device 100 adds, as the additional content, the captured images captured in real time to the combination source content. When the hash value to be recorded in the provenance information of the combined content is calculated, the imaging device 100 acquires the hash value of the combined content in which the captured images are combined in real time by using the hash value of the combination source content as the initial value. Since the imaging device 100 may hash the media data of the captured images that is the additional content, the amount of calculation for acquiring the hash value can be reduced.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, in a case where another content data is combined with the content data, it is possible to reduce the amount of calculation of the hash value given as the information for certifying authenticity.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066364, filed April 14, 2025, which is hereby incorporated by reference herein in its entirety.

What is claimed is:

1. An information processing device comprising:
a processor; and
a memory storing a program which, when executed by the processor, causes the information processing device to:
execute acquisition processing of acquiring a hash value of content data; and
record the hash value acquired in the acquisition processing in a predetermined region of a content file that stores the content data,
wherein, when combined content data obtained by combining second content data with first content data is generated, a third hash value of the combined content data is acquired in the acquisition processing by using, as an initial value, a first hash value of the first content data recorded in a first content file that stores the first content data or a second hash value of the second content data recorded in a second content file that stores the second content data.

2. The information processing device according to claim 1,
wherein, in the acquisition processing,
in a case where a size of the first content data is larger than a size of the second content data, the third hash value is acquired by using the first hash value as the initial value, and
in a case where the size of the second content data is larger than the size of the first content data, the third hash value is acquired by using the second hash value as the initial value.

3. The information processing device according to claim 1,
wherein the predetermined region is a region for recording provenance information of the content data,
in a case where one of the first content file or the second content file includes the provenance information, in the acquisition processing,
the third hash value is acquired by using the first hash value as the initial value in a case where the first content file includes the provenance information, and
the third hash value is acquired by using the second hash value as the initial value in a case where the second content file includes the provenance information.

4. The information processing device according to claim 1,
wherein, in the acquisition processing,
the third hash value is acquired by using the first hash value as the initial value in a case where a user selects the first content file, and
the third hash value is acquired by using the second hash value as the initial value in a case where the user selects the second content file.

5. The information processing device according to claim 1,
wherein the second content data is a captured image acquired in real time from an imaging device.

6. The information processing device according to claim 1,
wherein, in the acquisition processing, the first hash value is generated from the first content data in a case where the first hash value is not recorded in the first content file, and the second hash value is generated from the second content data in a case where the second hash value is not recorded in the second content file.

7. The information processing device according to claim 1,
wherein, in a case where the third hash value is acquired by using the second hash value as the initial value, a third content file that stores the combined content data includes management information for controlling the first content data to be played back before the second content data.

8. The information processing device according to claim 1,
wherein, in the acquisition processing, a hash value generated from data in a predetermined range of the content file is acquired as the hash value of the content data.

9. The information processing device according to claim 8,
wherein the predetermined range is a range set so as to match an alignment size when the hash value is generated.

10. An information processing method comprising:
executing acquisition processing of acquiring a hash value of content data; and
recording the hash value acquired in the acquisition processing in a predetermined region of a content file that stores the content data,
wherein, when combined content data obtained by combining second content data with first content data is generated, a third hash value of the combined content data is acquired in the acquisition processing by using, as an initial value, a first hash value of the first content data recorded in a first content file that stores the first content data or a second hash value of the second content data recorded in a second content file that stores the second content data.

11. A non-transitory computer readable medium that stores a program, wherein the program causes a computer to execute an information processing method comprising:
executing acquisition processing of acquiring a hash value of content data; and
recording the hash value acquired in the acquisition processing in a predetermined region of a content file that stores the content data,
wherein, when combined content data obtained by combining second content data with first content data is generated, a third hash value of the combined content data is acquired in the acquisition processing by using, as an initial value, a first hash value of the first content data recorded in a first content file that stores the first content data or a second hash value of the second content data recorded in a second content file that stores the second content data.
